(19) United States
(12) Patent Application Publication
(10) Pub. No.: US 2005/0062381 A1
(43) Pub. Date: Mar. 24, 2005

(54) Electron collector

(75) Inventor: Steven Aitken, Chelmsford (GB)

Correspondence Address: VENABLE, BAETJER, HOWARD AND CIVILETTI, LLP, P.O. BOX 34385, WASHINGTON, DC, 20043-9998, US

(73) Assignee: E 2V Technologies Limited, Chelmsford (GB)

(21) Appl. No.: 10/497,710

(22) PCT Filed: Dec. 4, 2002
(86) PCT No.: PCT/GB02/05459

(30) Foreign Application Priority Data
Dec. 4, 2001 (GB) 0128922.2

(51) Int. Cl. H01J 23/02; H01J 1/02; H01J 61/52

(52) U.S. Cl. 313/39; 315/5.38

(57) ABSTRACT

An electron collector assembly for an electron beam tube comprises an electron collector (2), which is at least partially surrounded by dielectric material, such as a dielectric fluid (5). A heat pipe (6), in communication with the dielectric fluid, is provided. Heat energy from the collector is transferred to the dielectric fluid, and hence to the heat pipe. By pumping coolant through the heat pipe, heat energy is removed from the vicinity of the collector. Previous proposals for cooling electron collectors necessarily involved non-conducting fluids as coolants. The provision of a dielectric fluid as an intermediary between the collector and the heat pipe allows greater freedom in the choice of coolant.

This invention relates to electron collector assemblies for electron beam tubes.

Electron beam tube devices, such as klystrons, travelling wave tubes (TWTs), inductive output tubes, etc, conventionally comprise four basic elements. Those elements are: an electron gun, an RF interaction circuit, a magnetic beam focussing arrangement and a collector assembly, which comprises an electron beam collector.

The function of the electron beam collector is to collect the electron beam and dissipate the remaining beam energy. Introducing a plurality of collector stages can increase the efficiency of an electron beam tube. This arrangement allows for the collection of lowest energy electrons at the first stage, with higher energy electrons being collected at stages that are depressed at a higher bias. The term “depressed” refers to the practice of introducing a potential difference between the collector stage and the interaction circuit.

As the electron beam passes through the RF interaction circuit, the beam usually loses some of its original energy. However, at least half of the original beam energy is maintained until the beam impinges on the collector. The absorption of the electron beam energy causes the collector to heat, thereby requiring the collector to be cooled.

In conventional electron beam devices, cooling is carried out using non-conducting coolant, such as de-ionised water. The use of such coolant prevents corrosion of the collector electrodes. However, use of these coolants typically involves other devices, such as active de-ionising systems and further requires high levels of maintenance of the cooling system, including regular and thorough cleaning.

The invention provides an electron collector assembly for an electron beam tube, the assembly comprising an electron collector at, least partially surrounded by dielectric material and a heat pipe in communication with the dielectric material.

The provision of a dielectric material as an intermediary between the collector and a coolant in the heat pipe allows for greater freedom in the choice of coolant. The invention obviates the need for non-conducting coolants, and the complex apparatus associated therewith.

Preferably, the material is a fluid, such as oil. However, a solid dielectric material may be used.

Advantageously, the heat pipe is located adjacent the collector. The heat pipe may take the form of a helix, with the collector being located in the coils of the helix.

A pump may be provided to pump coolant into and through the heat pipe.

Cooling may be further improved by the addition of one or more fins on the heat pipe, in order to increase the effective surface area available.

The invention will now be described, by way of example, with reference to the accompanying drawing. The drawing,

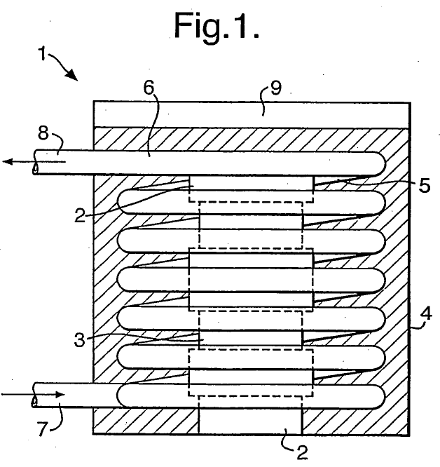

FIG. 1, is a partly sectional view of a collector assembly constructed according to the invention.

Referring to FIG. 1, there is shown a collector assembly, indicated generally by the reference numeral 1. The assembly 1 is part of an electron beam tube device (not shown). The collector assembly includes an electron collector 2. The collector 2 is a multi-stage depressed collector, although it will be appreciated that the invention may be used in conjunction with any type of electron collector. Insulating material 3 is provided on some regions of the collector 2, for electrical insulation purposes.

The electron collector 2 is contained within an enclosure 4. In accordance with the invention, the enclosure 4 is at least partially filled with a material 5 having dielectric properties. In this embodiment, the dielectric material 5 comprises a fluid. In use, as the collector heats up, heat energy is transferred to the dielectric fluid 5.

The collector assembly 1 is also provided with a heat pipe 6. In this embodiment, the heat pipe 6 is helical, and is arranged around, and coaxially with, the electron collector 2. The broken lines in the drawing show parts of the electron collector 2 behind the heat pipe 6. The heat pipe has an inlet 7 and an outlet 8. In use, coolant is introduced into the heat pipe at the inlet 7. Coolant is then pumped through the heat pipe 6, to the outlet 8, in order to remove heat from the dielectric fluid 5. As the coolant is not in direct communication with the collector 2, the user is not restricted to non-conducting coolant.

More readily available and/or efficient coolant may be used, such as ordinary water or a mixture of water and an alcohol, such as glycol.

An air gap 9 may be provided in the enclosure 4 containing the dielectric fluid 5 in order to allow for expansion of the fluid.

The invention has been described with reference to employing a dielectric fluid. However, a solid material having dielectric properties may be employed. In the case that a fluid dielectric is used, a pump may be provided in order to circulate the dielectric, thus ensuring intimate contact of the dielectric with the heat pipe.

Further variations may be made without departing from the scope of the invention. For example, the heat pipe may take the form of a snaking tube running from top to bottom of the collector enclosure, and around its inside diameter. In addition, or alternatively, fins may be provided for the heat pipe in order to increase its effective surface area, and hence its efficiency.

The invention allows surplus heat energy to be removed from the electron collector of a beam tube device without danger of corrosion of the collector electrodes or electrical conductivity between the coolant and electrodes, both of which were problems hitherto.

1. An electron collector assembly for an electron beam tube, the assembly comprising an electron collector at least partially surrounded by dielectric fluid and a heat pipe in communication with the dielectric fluid, the dielectric fluid acting as an intermediary between the collector and a coolant in the heat pipe.

2. An assembly as claimed in claim 1, in which the dielectric fluid is oil.

3. An assembly as claimed in claim 1, in which the heat pipe is located adjacent the collector.

4. An assembly as claimed in claim 1, in which the heat pipe is helical and is located around the collector.

5. An assembly as claimed in claim 1, further comprising means arranged to pump coolant through the heat pipe.

6. An assembly as claimed in claim 1, further comprising at least one fin for the heat pipe.

7. An assembly as claimed in claim 1, further comprising an enclosure for the collector and fluid, with an air gap being provided for the fluid.

8. An assembly as claimed in claim 1, further comprising a pump arranged to circulate the dielectric fluid.

9. An assembly as claimed in claim 1, in which the electron collector comprises a plurality of stages.

10. An electron beam tube including an electron collector assembly as claimed in claim 1.

11. Apparatus for cooling an electron collector of an electron beam tube, the apparatus comprising dielectric fluid in communication with the collector and a heat pipe in communication with the dielectric fluid.

12. A method of cooling an electron collector of an electron beam tube, comprising the steps of at least partially surrounding the collector with a dielectric fluid and providing a heat pipe in communication with the dielectric fluid.

13. A method as claimed in claim 12, further comprising the step of pumping coolant through the heat pipe.
